(19) United States
(12) Patent Application Publication
(10) Pub. No.: US 2024/0005159 A1
(43) Pub. Date: Jan. 4, 2024

(54) SIMPLIFICATION DEVICE AND SIMPLIFICATION METHOD FOR NEURAL NETWORK MODEL

(71) Applicant: NEUCHIPS CORPORATION, Hsinchu City (TW)

(72) Inventors: Po-Han Chen, New Taipei City (TW); Yi Lee, Tainan City (TW); Kai-Chiang Wu, Hsinchu City (TW); Youn-Long Lin, Hsinchu County (TW); Juinn-Dar Huang, Hsinchu County (TW)

(73) Assignee: NEUCHIPS CORPORATION, Hsinchu City (TW)

(21) Appl. No.: 17/892,145

(22) Filed: Aug. 22, 2022

(30) Foreign Application Priority Data
Jun. 30, 2022 (TW) 111124592

(51) Int. Cl. G06N 3/08

(52) U.S. Cl. CPC G06N 3/082

(57) ABSTRACT

A simplification device and a simplification method for neural network model are provided. The simplification method may simplify an original trained neural network model to a simplified trained neural network model, wherein the simplified trained neural network model includes at most two linear operation layers. The simplification method includes: converting the original trained neural network model into an original mathematical function; performing an iterative analysis operation on the original mathematical function to simplify the original mathematical function to a simplified mathematical function, wherein the simplified mathematical function has a new weight; computing the new weight by using multiple original weights of the original trained neural network model; and converting the simplified mathematical function to the simplified trained neural network model.

### CROSS-REFERENCE TO RELATED APPLICATION

This application claims the priority benefit of Taiwan application serial no. 111124592, filed on Jun. 30, 2022. The entirety of the above-mentioned patent application is hereby incorporated by reference herein and made a part of this specification.

### BACKGROUND

### Technical Field

The invention relates to machine learning/deep learning, and particularly relates to a simplification device and a simplification method for neural network model used in deep learning.

### Description of Related Art

In applications of neural network, it is often necessary to perform multilayer matrix multiplication and addition. For example, a multilayer perceptron (MLP) has multiple linear operation layers. Each linear operation layer generally performs matrix multiplication by using a weight matrix and an activation matrix, a multiplication result may be added to a bias matrix, and the result of the addition is used as an input of a next linear operation layer.

FIG. 1 is a generic schematic diagram of N consecutive linear matrix operations (N linear operation layers of a neural network model) in MLP. x on a left side of FIG. 1 is an input, and y on a right side of FIG. 1 is an output. There are N linear operation layers 10_1, . . . , 10_N between the input x and the output y. In the linear operation layer 10_1, a solid line module 12_1 represents a linear matrix operation, and dotted line modules 11_1 and 13_1 represent matrix transpose operations that are determined whether to be omitted according to a practical application. The linear matrix operation 12_1 is, for example, a matrix multiply operation, a matrix add operation, a matrix multiply-accumulate operation, or other linear matrix operations. In the linear operation layer 10_N, the solid line module 12_N represents the linear matrix operation, and the dotted line modules 11_N and 13_N represent the matrix transpose operations that are determined whether to be omitted according to a practical application. A dotted line arrow at the bottom of FIG. 1 represents a residual connection. The residual connection is a special matrix addition that is determined whether to be omitted according to a practical application. It may be clearly seen from FIG. 1 that an inference time of a neural network has a great correlation with a number of layers thereof and a calculation amount of matrix operations.

Along with increasing enlargement and complexity of the neural network model, the number of layers of the linear operation layer increases, and a size of the matrix involved in each layer increases. Without upgrading hardware specifications and improving the computing architecture, time (or even power consumption) required for inference may be increased continuously. In order to speed up the inference time of the neural network, how to simplify the original trained neural network model and make the simplified trained neural network model equivalent to the original trained neural network model is one of many important technical issues in this field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention is directed to a simplification device and a simplification method for neural network model, which simplify an original trained neural network model.

In an embodiment of the invention, the simplification method for neural network model is configured to simplify an original trained neural network model to a simplified trained neural network model, wherein the simplified trained neural network model includes at most two linear operation layers. The simplification method includes: receiving the original trained neural network model; calculating a first new weight of the at most two linear operation layers of the simplified trained neural network model by using a plurality of original weights of the original trained neural network model; and generating the simplified trained neural network model based on the first new weight.

In an embodiment of the invention, the simplification device includes a memory and a processor. The memory stores a computer readable program. The processor is coupled to the memory to execute the computer readable program. The processor executes the computer readable program to realize the above-mentioned simplification method for neural network model.

In an embodiment of the invention, the above-mentioned non-transitory storage medium is used for storing a computer readable program. Wherein, the computer readable program is executed by a computer to realize the above-mentioned simplification method for neural network model.

Based on the above description, the simplification method for neural network model according to the embodiments of the invention may simplify the original trained neural network model with multiple linear operation layers into the simplified trained neural network model of at most two linear operation layers. In some embodiments, the simplification method converts the original trained neural network model into an original mathematical function; and performs an iterative analysis operation on the original mathematical function to simplify the original mathematical function to a simplified mathematical function, where the simplified mathematical function has a first new weight. Generally, each weight of the trained neural network model may be considered as a constant. By using a plurality of original weights (constants) of the original trained neural network model, the simplification method may pre-calculate the first new weight to serve as a weight for the linear operation layer of the simplified trained neural network model. Under the premise that the simplified trained neural network model is equivalent to the original trained neural network model, a number of layers of the linear operation layers of the simplified trained neural network model is much less than that of the original trained neural network model. Therefore, the inference time of the neural network may be effectively speeded up.

To make the aforementioned more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a generic schematic diagram of N consecutive linear matrix operations (N linear operation layers of a neural network model) in multilayer perceptron (MLP).

FIG. 2 is a schematic diagram of circuit blocks of a simplification device according to an embodiment of the invention.

FIG. 3 is a schematic flowchart of a simplification method for neural network model according to an embodiment of the invention.

FIG. 4 is a schematic flowchart of a simplification method for neural network model according to another embodiment of the invention.

FIG. 5 is a schematic diagram of simplifying an original trained neural network model with more layers into a simplified trained neural network model with at most two linear operation layers according to an embodiment of the invention.

FIG. 6A to FIG. 6D are schematic diagrams of a linear operation layer of the original trained neural network model shown in FIG. 5 according to different embodiments of the invention.

FIG. 7 is a schematic flowchart of a simplification method for neural network model according to yet another embodiment of the invention.

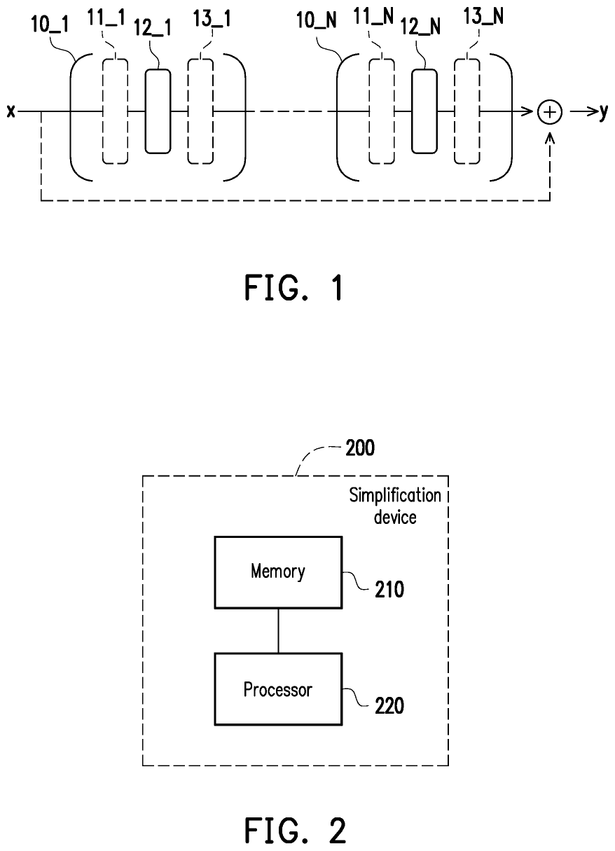

### DESCRIPTION OF THE EMBODIMENTS

A term “couple” used in the full text of the disclosure (including the claims) refers to any direct and indirect connections. For example, if a first device is described to be coupled to a second device, it is interpreted as that the first device is directly coupled to the second device, or the first device is indirectly coupled to the second device through other devices or connection means. “First”, “second”, etc. mentioned in the specification (including the claims) are merely used to name discrete components and should not be regarded as limiting the upper or lower bound of the number of the components, nor is it used to define a manufacturing order or setting order of the components. Moreover, wherever possible, components/members/steps using the same referential numbers in the drawings and description refer to the same or like parts. Components/members/steps using the same referential numbers or using the same terms in different embodiments may cross-refer related descriptions.

The following embodiments will exemplify a neural network simplification technology based on matrix operation reconstruction. The following embodiments may simplify a plurality of successive linear operation layers into at most two layers. The reduction/simplification of the number of layers of the linear operation layers may greatly reduce computational requirements, thereby reducing energy consumption and speeding up an inference time.

FIG. 2 is a schematic diagram of circuit blocks of a simplification device 200 according to an embodiment of the invention. According to practical applications, the simplification device 200 shown in FIG. 2 may be a computer or other electronic devices capable of executing programs. The simplification device 200 includes a memory 210 and a processor 220. The memory 210 stores a computer readable program. The processor 220 is coupled to the memory 210. The processor 220 may read and execute the computer readable program from the memory 210, thereby implementing a simplification method for neural network model that is to be described in detail later. According to an actual design, in some embodiments, the processor 220 may be implemented as one or more controllers, microcontrollers, microprocessors, central processing units (CPU), application-specific integrated circuits (ASIC), digital signal processors (DSP), field programmable gate arrays (FPGA) and/or various logic blocks, modules and circuits in other processing units.

In some application examples, the computer readable program may be stored in a non-transitory storage medium (not shown). In some embodiments, the non-transitory storage medium includes, for example, a read only memory (ROM), a tape, a disk, a card, a semiconductor memory, a programmable logic circuit and/or a storage device. The storage device includes a hard disk drive (HDD), a solid-state drive (SSD), or other storage devices. The simplification device 200 (for example, a computer) may read the computer readable program from the non-transitory storage medium, and temporarily store the computer readable program in the memory 210. In other application examples, the computer readable program may also be provided to the simplification device 200 via any transmission medium (a communication network or broadcast waves, etc.). The communication network is, for example, the Internet, a wired communication network, a wireless communication network, or other communication media.

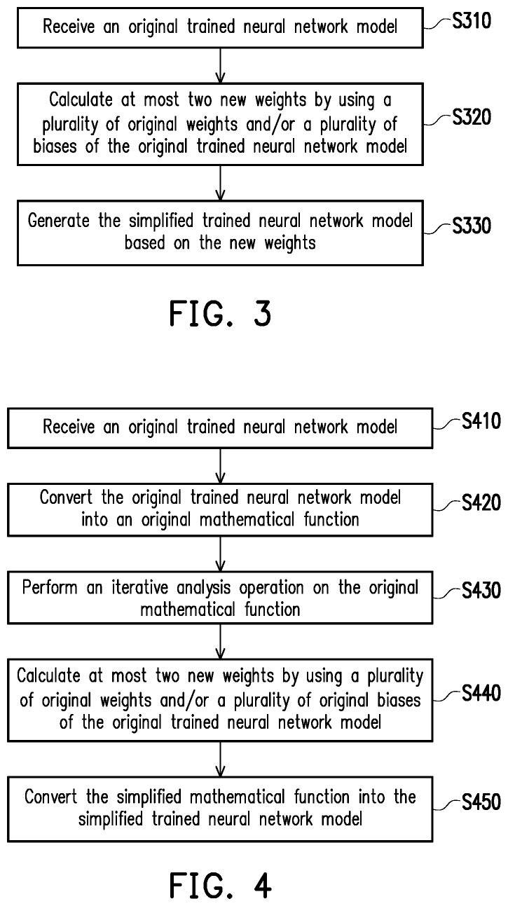

FIG. 3 is a schematic flowchart of a simplification method for neural network model according to an embodiment of the invention. The simplification method shown in FIG. 3 may simplify an original trained neural network model with more layers into a simplified trained neural network model with at most two linear operation layers. In step S310, the processor 220 may receive the original trained neural network model. In general, each weight and each bias of a trained neural network model may be regarded as a constant. In step S320, the processor 220 may calculate at most two sets of new weights (for example, at most two weight matrices) by using a plurality of original weights and/or a plurality of original biases of the original trained neural network model. According to the actual design, the original weight and/or the original bias may be a vector (vector), a matrix (matrix), a tensor or other data. In step S330, the processor 220 may generate a simplified trained neural network model based on the new weights. Namely, the new weights calculated in step S320 may be used as first new weights of at most two linear operation layers of the simplified trained neural network model.

In step S320 may pre-calculate new weights and new biases of at most two linear operation layers of the simplified trained neural network model (in some applications, there may be no bias). Namely, the new weights and new biases of at most two linear operation layers of the simplified trained neural network model are also constants. Therefore, a user may use the simplified trained neural network model with at most two linear operation layers to perform inferences, and an inference effect is equivalent to the original trained neural network model with more layers.

For example, it is assumed that the original trained neural network model is denoted as y=(x@w₁+b₁)@w₂+b₂, where y represents an output of the original trained neural network model and x represents an input of the original trained neural network model, @ represents any linear operation (such as a matrix multiply operation, a matrix add operation, a matrix multiply-accumulate operation, or other linear matrix operations), w₁ and b₁ respectively represent an original weight and an original bias of a first linear operation layer of the original trained neural network model, and w₂ and b₂ respectively represent an original weight and an original bias of a second linear operation layer of the original trained neural network model. According to practical applications, the original biases b₁ and/or b₂ may be 0 or other constants.

The processor 220 may simplify the original trained neural network model y=(x@w₁+b₁)@w₂+b₂ of two layers to a simplified trained neural network model y=x@W_{I}+B_{I} of a single linear operation layer, where y represents an output of the simplified trained neural network model, x represents an input of the simplified trained neural network model, W_{I} represents a first new weight, and B_{I} represents a new bias of the simplified trained neural network model. Simplification details are described in the next paragraph.

The original trained neural network model y=(x@w₁+b₁)@w₂+b₂ may be expanded as y=x@w₁@w₂+b₁@w₂+b₂. Namely, the processor 220 may pre-calculate W_{I}=w₁@w₂ to determine the first new weight W_{I} of the simplified trained neural network model y=x@W_{I}+B_{I}. The processor 220 may also pre-calculate B_{I}=b₁@w₂+b₂ to determine a new bias B_{I} of the simplified trained neural network model y=x@W_{I}+B_{I}. Therefore, the simplified trained neural network model y=x@W_{I}+B_{I} with a single linear operation layer may be equivalent to the original trained neural network model y=(x@w₁+b₁) @w₂+b₂ with two linear operation layers.

For another example, it is assumed that the original trained neural network model is denoted as y=((x@w₁+b₁)^{T}@w₂+b₂)^{T}@w₃, where ( )^{T} represents a matrix transpose operation, w₁ and b₁ respectively represent an original weight and an original bias of the first linear operation layer of the original trained neural network model, w₂ and b₂ respectively represent an original weight and an original bias of the second linear operation layer of the original trained neural network model, and w₃ represents an original weight of a third linear operation layer of the original trained neural network model. In the example, an original bias of the third linear operation layer is assumed to be 0 (i.e., the third linear operation layer has no bias).

The processor 220 may simplify the original trained neural network model y=((x@w₁+b₁)^{T}@w₂+b₂)^{T}@w₃ of three linear operation layers to a simplified trained neural network model y=W_{II}® (x@W_{I}+B_{I}) of at most two linear operation layers. Where, W_{I} represents the first new weight of the first linear operation layer of the simplified trained neural network model, and B_{I} represents the first new bias of the first linear operation layer of the simplified trained neural network model. The processor 220 may also calculate a second new weight W_{II} of the second linear operation layer of the simplified trained neural network model by using at least one original weight of the original trained neural network model. The processor 220 may further calculate a second new bias B_{I} of the simplified trained neural network model by using at least one original weight and at least one original bias of the original trained neural network model. Simplification details are described in the next paragraph.

The original trained neural network model y=((x@w₁+b₁)^{T}@w₂+b₂)^{T}@w₃ may be expanded as y=(w₂)^{T}@x@w₁@w₃+(w₂)^{T}@b₁@w₃+(b₂)^{T}@w₃, and rewrote as y=(w₂)^{T}@X@w₁@w₃+(w₂)^{T}@b₁@w₃+(w₂)^{T}@((w₂)^{T})⁻¹@(b₂)^{T}@w₃. Therefore, the original trained neural network model may be organized as y=(w₂)^{T}@[x@w₁@w₃+b₁@w₃+((w₂)^{T})⁻¹@(b₂)^{T}@w₃]. Namely, the processor 220 may pre-calculate W_{II}=(w₂)^{T} to determine the second new weight W_{II} of the simplified trained neural network model y=W_{II}@(x@W_{I}+B_{I}). The processor 220 may pre-calculate W_{I}=w₁@w₃ to determine the first new weight W_{I} of the simplified trained neural network model y=W_{II}@(x@W_{I}+B_{I}). The processor 220 may further pre-calculate B_{I}=b₁@w₃+((w₂)^{T})⁻¹@(b₂)^{T}@w₃ to determine the first new bias B_{I} of the simplified trained neural network model y=W_{II}@(x@W_{I}+B_{I}). Therefore, the simplified trained neural network model y=W_{II}@(x@W_{I}+B_{I}) with at most two linear operation layers may be equivalent to the original trained neural network model y=((x@w₁+b₁)^{T}@w₂+b₂)^{T}@w₃ with three linear operation layers.

FIG. 4 is a schematic flowchart of a simplification method for neural network model according to another embodiment of the invention. The simplification method shown in FIG. 4 may simplify an original trained neural network model with more layers into a simplified trained neural network model with at most two linear operation layers. In step S410, the processor 220 may receive the original trained neural network model. In step S420, the processor 220 may convert the original trained neural network model into an original mathematical function. In step S430, the processor 220 may perform an iterative analysis operation on the original mathematical function to simplify the original mathematical function to a simplified mathematical function. Where, the simplified mathematical function has two more new weights. In step S440, the processor 220 may calculate at most two new weights (for example, at most two weight matrices) of the simplified mathematical function by using a plurality of original weights and/or a plurality of original biases of the original trained neural network model. In step S450, the processor 220 may convert the simplified mathematical function into the simplified trained neural network model.

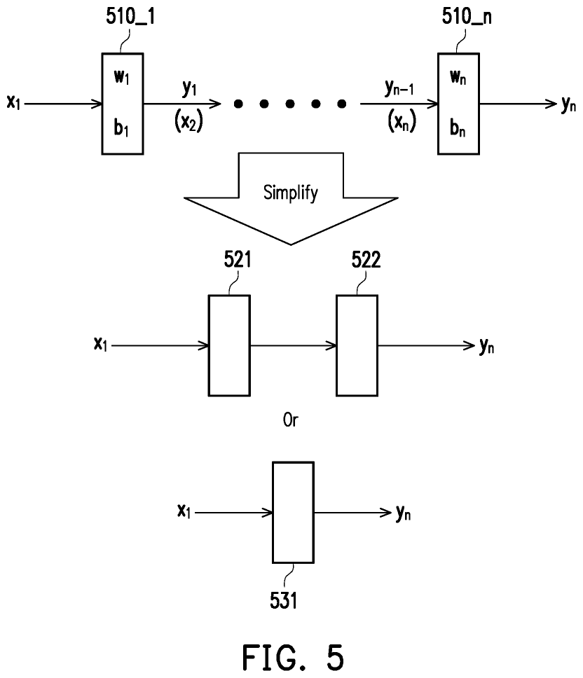

FIG. 5 is a schematic diagram of simplifying an original trained neural network model with more layers into a simplified trained neural network model with at most two linear operation layers according to an embodiment of the invention. The original trained neural network model shown in FIG. 5 includes n linear operation layers 510_1, . . . , 510_n. The linear operation layer 510_1 performs a linear operation (for example, a matrix multiply operation, a matrix add operation, a matrix multiply-accumulate operation, or other linear matrix operations) on an input x₁ by using the original weight w₁ and the original bias b₁ to generate an output y₁. The output y₁ may be used as an input x₂ of a next linear operation layer (not shown). Deduced by analogy, the linear operation layer 510_n receives an output yₙ₋₁ of a previous linear operation layer (not shown) to serve as an input xₙ. The linear operation layer 510_n performs a linear operation (for example, a matrix multiply operation, a matrix add operation, a matrix multiply-accumulate operation, or other linear matrix operations) on the input xₙ by using an original weight wₙ and an original bias bₙ to generate an output yₙ.

The simplification method shown in FIG. 4 may simplify the original trained neural network model shown in an upper part of FIG. 5 into a simplified trained neural network model with at most two linear operation layers, such as a simplified trained neural network model with linear operation layers 521 and 522 shown in a middle part of FIG. 5, or a simplified trained neural network model with a linear operation layer 531 shown in a lower part of FIG. 5.

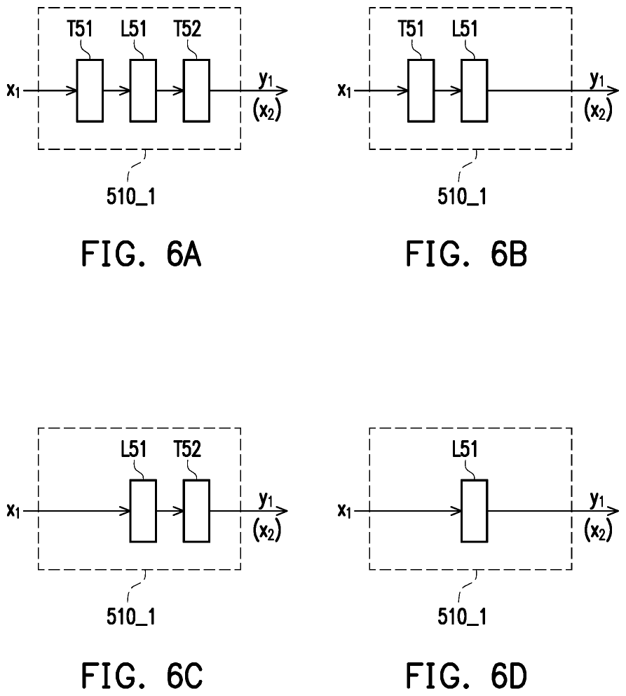

FIG. 6A to FIG. 6D are schematic diagrams of the linear operation layer 510_1 of the original trained neural network model shown in FIG. 5 according to different embodiments of the invention. Description of other linear operation layers (for example, the linear operation layer 510_n) of the original trained neural network model shown in FIG. 5 may be deduced with reference to the related descriptions of the linear operation layer 510_1, so that detailed description thereof is not repeated. In the embodiment shown in FIG. 6A, the linear operation layer 510_1 may include a matrix transpose operation T51, a linear operation L51 and a matrix transpose operation T52. In the embodiment shown in FIG. 6B, the linear operation layer 510_1 may include the matrix transpose operation T51 and the linear operation L51. In the embodiment shown in FIG. 6C, the linear operation layer 510_1 may include the linear operation L51 and the matrix transpose operation T52. In the embodiment shown in FIG. 6D, the linear operation layer 510_1 may include the linear operation L51 without the matrix transpose operation.

In step S420 shown in FIG. 4, the processor 220 may convert the original trained neural network model into an original mathematical function. For example, the processor 220 may convert the original trained neural network model shown in the upper part of FIG. 5 into an original mathematical function y=(( . . . ((x^{T0}@w₁+b₁)^{T1}@w₂+b₂)^{T2} . . . )^{Tn-1}@wₙ+bₙ)^{Tn}, where n is an integer greater than 1, the input x of the original mathematical function is equivalent to the input x₁ of the original trained neural network model shown in the upper part of FIG. 5, and the output y of the original mathematical function is equivalent to the output yₙ of the original trained neural network model shown in the upper part of FIG. 5. In the original mathematical function, T₀ represents whether to transpose the input x, @ represents any linear operation of the neural network model, w₁ and b₁ respectively represent an original weight and an original bias of the first linear operation layer 510_1 of the original trained neural network model, T1 represents whether to transpose a result of the first linear operation layer, w₂ and b₂ respectively represent an original weight and an original bias of a second linear operation layer (not shown in FIG. 5) of the original trained neural network model, T2 represents whether to transpose a result of the second linear operation layer, Tn−1 represents whether to transpose a result of an (n−1)^{th} linear operation layer (not shown in FIG. 5) of the original trained neural network model, wₙ and bₙ respectively represent an original weight and an original bias of an n^{th} linear operation layer 510_n of the original trained neural network model, and Tn represents whether to transpose a result of the n^{th} linear operation layer 510_n.

In step S430, the processor 220 may perform an iterative analysis operation on the original mathematical function to simplify the original mathematical function to a simplified mathematical function. Where, the simplified mathematical function has two more new weights. The iterative analysis operation includes n iterations. In a first iteration of the n iterations, the input x of the original mathematical function is used as a starting point, the processor 220 may extract (x^{T0}@w₁+b₁)^{T1} corresponding to the first linear operation layer 510_1 from the original mathematical function. In the first iteration, the processor 220 may define X₁ as x, and check T₀. When T₀ represents “transpose”, the processor 220 may define F₁ as (X₁)^{T} (i.e., transposed X₁), define F′₁ as F₁@w₁+b₁, and check T₁, where ( )^{T} represents a transpose operation. When T0 represents “transpose” and T1 represents “transpose”, the processor 220 may define Y₁ as (F′₁)^{T} (i.e., transposed F′₁), such that Y₁=(w₁)^{T}@X₁+(b₁)^{T}. When T0 represents “transpose” and T1 represents “not transpose”, the processor 220 may define Y₁ as F′₁ such that Y₁=(X₁)^{T}@w₁+b₁.

In the first iteration, when T0 represents “not transpose”, the processor 220 may define F₁ as X₁, define F′₁ as F₁@w₁+b₁, and check T₁. When T0 represents “not transpose” and T1 represents “transpose”, the processor 220 may define Y₁ as (F′₁)^{T} (i.e., transposed F′₁) such that Y₁=(w₁)^{T}@(X₁)^{T}+(b₁)^{T}. When T0 represents “not transpose” and T1 represents “not transpose”, the processor 220 may define Y₁ as F′₁ such that Y₁=X₁@w₁+b₁. After the first iteration, the processor 220 may use Y₁ to replace (x^{T0}@w₁+b₁)^{T1} in the original mathematical function, so that the original mathematical function becomes y=(( . . . (Y₁@w₂+b₂)^{T2} . . . )^{Tn-1}@wₙ±bₙ)^{Tn}.

In a second iteration of the n iterations, Y₁ is taken as the starting point, the processor 220 may extract (Y₁@w₂+b₂)^{T2} corresponding to the second linear operation layer from the original mathematical function. The processor 220 may define X₂ as Y₁, define F₂ as X₂, define F′₂ as F₂@w₂+b₂, and check T2. When T2 represents “transpose”, the processor 220 may define Y₂ as (F′₂)^{T} (i.e., the transposed F′₂), such that Y₂=(w₂)+b₂. When T2 represents “not transpose”, the processor 220 may define Y₂ as F′₂ such that Y₂=X₂@w₂+b₂. After the second iteration, the processor 220 may replace (Y₁@w₂+b₂)^{T2} in the original mathematical function with Y₂, so that the original mathematical function becomes y=(( . . . Y₂ . . . )^{Tn-1}@wₙ+bₙ)^{Tn}. Deduced by analogy until the end of the n iterations. After the n iterations are complete, the processor 220 may generate a simplified mathematical function. The simplified mathematical function may be y=x@W_{I}+B_{I} or y=W_{II}@(x@W_{I}+B_{I})+B_{II}, where W_{I} and B_{I} represent a first new weight and a first new bias of the same linear operation layer. value, and W_{II} and B_{II} represent a second new weight and a second new bias of a next linear operation layer.

In step S440, the processor 220 may calculate the new weight W_{I}, the new weight W_{II}, the new bias B_{I} and/or the new bias B_{II} by using the original weights w₁ to wₙ and/or the original biases b₁ to bₙ of the original trained neural network model. The iterative analysis operation uses a part of or all of these original weights w₁ to wₙ to pre-calculate a first constant to serve as the first new weight W_{I} (such as a new weight of the linear operation layer 521 shown in a middle part of FIG. 5 or a new weight of the linear operation layer 531 shown in a lower part of FIG. 5), uses at least one of the original weights w₁ to wₙ to pre-calculate a second constant to serve as the second new weight W_{II} (for example, a new weight of the linear operation layer 522 shown in the middle part of FIG. 5), uses at least one of the original weights w₁ to wₙ and at least one of the original biases b₁ to bₙ to pre-calculate a third constant to serve as the first new bias B_{I} (for example, the new bias of the linear operation layer 521 shown in the middle part of FIG. 5 or the new bias of the linear operation layer 531 shown in the lower part of FIG. 5), and uses “at least one of the original weights w₁ to wₙ” or “at least one of the original biases b₁ to bₙ” or “at least one of the original weights w₁ to wₙ and at least one of the original biases b₁ to bₙ” to pre-calculate a fourth constant to serve as the second new bias B_{II} (for example, the new bias of the linear operation layer 522 shown in the middle part of FIG. 5).

In step S450, the processor 220 may convert the simplified mathematical function into a simplified trained neural network model. For example, the processor 220 may convert the simplified mathematical function y=W_{II}@(x@W_{I}+B_{I})+B_{II} into the simplified trained neural network model shown in the middle part of FIG. 5. In another example, the processor 220 may convert the simplified mathematical function y=x@W_{I}+B_{I} into a simplified trained neural network model.

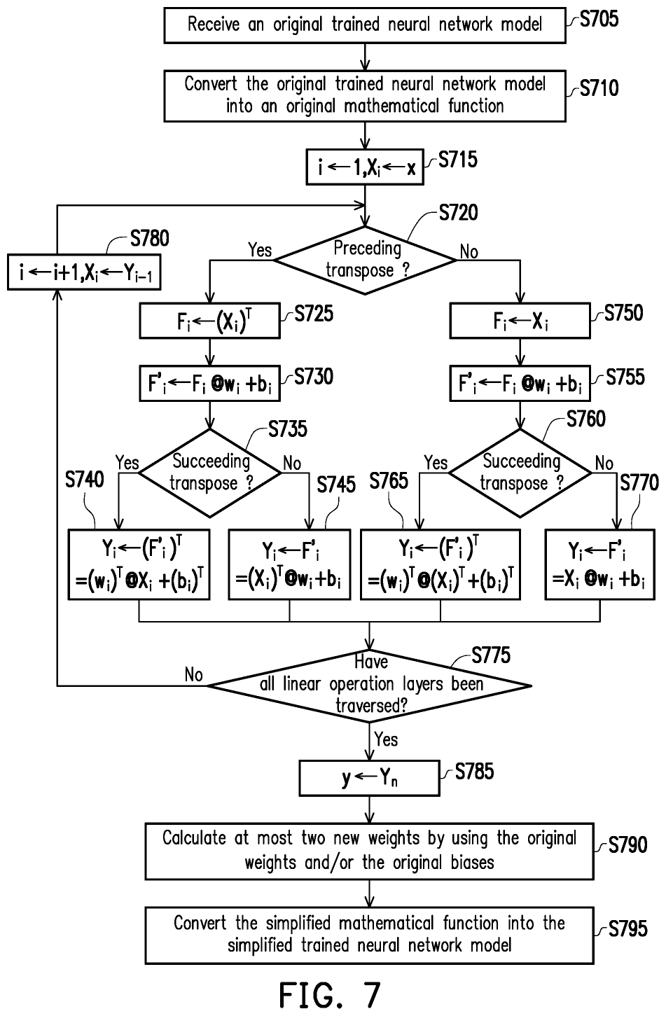

FIG. 7 is a schematic flowchart of a simplification method for neural network model according to yet another embodiment of the invention. The simplification method shown in FIG. 7 may simplify an original trained neural network model with more layers into a simplified trained neural network model with at most two linear operation layers. For steps S705, S710, S790 and S795 shown in FIG. 7, reference may be made to the related descriptions of steps S410, S420, S440 and S450 shown in FIG. 4, and details thereof are not repeated. For the remaining steps shown in FIG. 7, reference may be made to the relevant description of step S430 shown in FIG. 4 to perform n iterations (iterative analysis operations) on the n linear operation layers 510_1 to 510_n of the original trained neural network model shown in FIG. 5.

In step S715 shown in FIG. 7, the processor 220 may initialize i to “1” to perform the first iteration of the n iterations. In the first iteration of the n iterations, the input x of the original mathematical function y=(( . . . ((x^{T0}@w₁ b₁)^{T1}@w₂+b₂)^{T2} . . . )^{Tn-1}@wₙ+bₙ)^{Tn} is taken as a starting point, and the processor 220 may extract (x^{T0}@w₁+b₁)^{T1} corresponding to the first linear operation layer 510_1 from the original mathematical function. In step S715, the processor 220 may define Xᵢ as x. In step S720, the processor 220 may check whether there is a “preceding transpose” in a current linear operation layer (for example, check T0 in the first iteration). Taking FIG. 6A to FIG. 6D as an example, a matrix transpose operation T51 shown in FIG. 6A and FIG. 6B may be used as an example of “preceding transpose”, while the linear operation layer 510_1 shown in FIG. 6C and FIG. 6D has no “preceding transpose”.

When a judgment result of step S720 is “yes” (the current linear operation layer has the preceding transpose), for example, in the first iteration, when TO represents “transpose”, the processor 220 may perform step S725 to define Fᵢ as (Xᵢ)^{T} (i.e., the transposed Xᵢ). In step S730, the processor 220 may define F′ᵢ as Fᵢ@wᵢ+bᵢ. In step S735, the processor 220 may check whether there is a “succeeding transpose” in the current linear operation layer (for example, check T1 in the first iteration). Taking FIG. 6A to FIG. 6D as an example, the matrix transpose operation T52 shown in FIG. 6A and FIG. 6C may be used as an example of “succeeding transpose”, while the linear operation layer 510_1 shown in FIG. 6B and FIG. 6D has no “succeeding transpose”.

When the judgment result of step S735 is “yes” (the current linear operation layer has the succeeding transpose), for example, in the first iteration, when T1 indicates “transpose”, the processor 220 may perform step S740 to define Yᵢ as (F′ᵢ)^{T} (i.e., the transposed F′ᵢ), such that Yᵢ=(wᵢ)^{T}@X₁+(bᵢ)^{T}. When the judgment result of step S735 is “none” (the current linear operation layer has no succeeding transpose), for example, in the first iteration, when T1 indicates “not transpose”, the processor 220 may proceed to step S745 to define Yᵢ as F′ᵢ, such that Yᵢ=(Xᵢ)^{T}@wᵢ+bᵢ.

When the judgment result of step S720 is “none” (the current linear operation layer has no preceding transpose), for example, in the first iteration, when TO indicates “not transpose”, the processor 220 may perform step S750 to define Fᵢ as Xᵢ. In step S755, the processor 220 may define F′ᵢ as Fᵢ@wᵢ+bᵢ. In step S760, the processor 220 may check whether there is the “succeeding transpose” in the current linear operation layer (for example, check T1 in the first iteration). Step S760 may be deduced with reference of the relevant description of step S735, and details thereof are not repeated.

When the judgment result of step S760 is “yes”, for example, in the first iteration, when T1 indicates “transpose”, the processor 220 may proceed to step S765 to define Yᵢ as (F′ᵢ)^{T} (i.e., transposed F′ᵢ) such that Yᵢ=(wᵢ)^{T}@(Xᵢ)^{T}+(bᵢ)^{T}. When the judgment result of step S760 is “none”, for example, in the first iteration when T1 indicates “not transpose”, the processor 220 may proceed to step S770 to define Yᵢ as F′ᵢ, such that Yᵢ=X₁@wᵢ+bᵢ.

After any one of steps S740, S745, S765 and S770 ends, the processor 220 may proceed to step S775 to determine whether all linear operation layers of the original trained neural network model have been traversed. When there is still a linear operation layer in the original trained neural network model that has not been subjected to iterative analysis (the determination result in step S775 is “No”), the processor 220 may proceed to step S780 to accumulate i by 1, and define X₁ is Yᵢ₋₁. After step S780 ends, the processor 220 may perform step S720 again to perform a next iteration of the n iterations.

When all of the linear operation layers in the original trained neural network model have been subjected to iterative analysis (the determination result of step S775 is “Yes”), the processor 220 may proceed to step S785 to define the output y as Yᵢ. Taking n iterations as an example, step S785 may define the output y as Yₙ. The processor 220 may perform step S790 to calculate at most two sets of new weights W_{I} and/or W_{II} of the simplified mathematical function by using a plurality of the original weights w₁ to wₙ and/or a plurality of the original biases b₁ to bₙ of the original trained neural network model. W_{I} and W_{II} represent two weight matrices. In step S450, the processor 220 may convert the simplified mathematical function into the simplified trained neural network model. Therefore, the processor 220 may simplify the original trained neural network model of n linear operation layers to the simplified trained neural network model of at most two linear operation layers, for example, y=W_{II}® (x@W_{I}+B_{I})+B_{II} or y=x@W_{I}+B_{I}.

For example, it is assumed that the original mathematical function is y=((x@w₁+b₁)^{T}@w₂+b₂)^{T}@w₃+b₃. In the first iteration (i=1), the input x of the original math function is taken as a starting point, the processor 220 may extract the first linear operation layer (x@w₁+b₁)^{T} from the original math function. In step S715, the processor 220 may define X₁ as x. Since there is no “preceding transpose” in the current linear operation layer, the processor 220 may proceed to step S750 to define F₁ as X₁. In step S755, the processor 220 may define F′₁ as F₁@w₁+b₁. Since the current linear operation layer has “succeeding transpose”, the processor 220 may perform step S765 to define Y₁ as (F′₁)^{T} (i.e., the transposed F′₁), such that Y₁=(w₁)^{T}@(X₁)^{T}+(b₁)^{T}. Since there is still a linear operation layer in the original trained neural network model that has not been subjected to iterative analysis, the processor 220 may perform step S780 to accumulate i by 1 (i.e., i=2), and define X₂ as Y₁.

The processor 220 may execute step S720 again to perform a second iteration. In the second iteration (i=2), X₂ is taken as the starting point, the processor 220 may extract the second linear operation layer (X₂@w₂+b₂)^{T} from the original mathematical function y=(X₂@w₂+b₂)^{T}@w₃+b₃. Since there is no “preceding transpose” in the current linear operation layer, the processor 220 may proceed to step S750 to define F₂ as X₂. In step S755, the processor 220 may define F′₂ as F₂@w₂+b₂. Since the current linear operation layer has “succeeding transpose”, the processor 220 may execute step S765 to define Y₂ as (F′₂)^{T} (i.e., the transposed F′₂), such that Y₂=(w₂)^{T}@(X₂)^{T}+(b₂)^{T}. Since there is still a linear operation layer in the original trained neural network model that has not been subjected to iterative analysis, the processor 220 may execute step S780 to accumulate i by 1 (i.e., i=3), and define X₃ as Y₂.

The processor 220 may execute step S720 again to perform a third iteration. In the third iteration (i=3), X₃ is taken as the starting point, the processor 220 may extract a third linear operation layer X₃@w₃+b₃ from the original mathematical function y=X₃@w₃+b₃. Since there is no “preceding transpose” in the current linear operation layer, the processor 220 may proceed to step S750 to define F₃ as X₃. In step S755, the processor 220 may define F′₃ as F₃@w₃+b₃. Since there is no “succeeding transpose” in the current linear operation layer, the processor 220 may proceed to step S770 to define Y₃ as F′₃, such that Y₃=X₃@w₃+b₃. Since all linear operation layers in the original trained neural network model have been subjected to iterative analysis, the processor 220 may proceed to step S785 to define the output y as Y₃.

After completing 3 iterations, the original mathematical function turns into y=((w₂)^{T}@((w₁)^{T}@(x)^{T}+(b₁)^{T})^{T}+(b₂)^{T})@w₃+b₃. The transformed original math function may be expanded as y=(w₂)^{T}@x@w₁@w₃+(w₂)^{T}@b₁@w₃+(b₂)^{T}@w₃+b₃. In some embodiments, y=(w₂)^{T}@x@w₁@w₃+(w₂)^{T}@b₁@w₃+(b₂)^{T}@w₃+b₃ may be sorted into y=(w₂)^{T}@[x@ w₁@w₃+b₁@w₃]+(b₂)^{T}@w₃+b₃. Namely, the processor 220 may pre-calculate W_{II}=(w₂)^{T}, W_{I}=w₁@w₃, B_{I}=b₁@w₃, and B_{II}=(b₂)^{T}@W₃+b₃. Since w₁, w₂, w₃, b₁, b₂, and b₃ are all constants, W_{I}, W_{II}, B_{I}, and B_{II} are also constants. Based on this, the processor 220 may determine the first new weight W_{I}, the second new weight W_{II}, the first new bias B_{I} and the second new bias B_{II} of the simplified mathematical function y=W_{II}@(x@W_{I}+B_{I})+B_{II}.

In some other embodiments, y=(w₂)^{T}@x@w₁@w₃+(w₂)^{T}@b₁@w₃+(b₂)^{T}@w₃+b₃ may be rewritten as y=(w₂)^{T}@x@w₁@w₃+(w₂)^{T}@b₁@w₃+(w₂)^{T}@((w₂)^{T})⁻¹@(b₂)^{T} @w₃+b₃, and further sorted as y=(w₂)^{T}@[x@w₁@w₃+b₁@w₃ ((w₂)^{T})⁻¹@(b₂)^{T}@w₃]+b₃. Namely, the processor 220 may pre-calculate W_{II}=(w₂)^{T}, W_{I}=w₁@w₃, B_{I}=b₁ @w₃+((w₂)^{T})⁻¹@(b₂)^{T}@w₃, and B_{II}=b₃. Therefore, the processor 220 may determine the first new weight W_{I}, the second new weight W_{II}, the first new bias B_{I}, and the second new bias B_{II} of the simplified mathematical function y=W_{II}@(x@W_{I}+B_{I})+B_{II}.

Therefore, the processor 220 may simplify the original trained neural network model y=((x@w₁+b₁)^{T}@w₂+b₂)^{T}@w₃+b₃ with three linear operation layers to the simplified trained neural network model y=W_{II}@(x@W_{I}+B_{I})+B_{II} with at most two linear operation layers. The simplified trained neural network model y=W_{II}@(x@W_{I}+B_{I})+B_{II} with at most two linear operation layers may be equivalent to the original trained neural network model y=((x@w₁+b₁)^{T}@w₂+b₂)^{T}@w₃+b₃ with three linear operation layers.

The above embodiments may also be applied to trained neural network models with residual connections. For example, in yet other embodiments, it is assumed that the original mathematical function (original trained neural network model) is y=((x@w₁+b₁)^{T}@w₂+b₂)^{T}@w₃+x. After completing 3 iterations, the original mathematical function turns into y=(w₂)^{T}@[x@w₁@w₃+b₁@w₃+((w₂)^{T})⁻¹@(b₂)^{T}@w₃]+x. Namely, the processor 220 may pre-calculate the first new weight W_{I}, the second new weight W_{II} and the first new bias B_{I} in the simplified mathematical function y=W_{II}@(x@W_{I}+B_{I})+x, i.e., W_{II}=(w₂)^{T}, W_{I}=w₁@w₃, and B_{I}=b₁@w₃+((w₂)^{T})⁻¹@(b₂)^{T}@w₃ (in this example, the second new bias B_{II} is 0).

In summary, under the premise that the simplified trained neural network model is equivalent to the original trained neural network model, the number of the linear operation layers of the simplified trained neural network model is much less than the number of the original trained neural network model. Therefore, the inference time of the neural network may be effectively speeded up.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A simplification method for neural network model, configured to simplify an original trained neural network model to a simplified trained neural network model, wherein the simplified trained neural network model comprises at most two linear operation layers, and the simplification method for neural network model comprises:
receiving the original trained neural network model;
calculating a first new weight of the at most two linear operation layers of the simplified trained neural network model by using a plurality of original weights of the original trained neural network model; and
generating the simplified trained neural network model based on the first new weight.

2. The simplification method for neural network model as claimed in claim 1, wherein the simplified trained neural network model is denoted as y=x@W_{I}+B_{I}, y represents an output of the simplified trained neural network model, @ represents any linear operation of the simplified trained neural network model, x represents an input of the simplified trained neural network model, W_{I} represents the first new weight, and B_{I} represents a new bias of the simplified trained neural network model.

3. The simplification method for neural network model as claimed in claim 2, wherein the any linear operation @ comprises a matrix multiply-accumulate operation.

4. The simplification method for neural network model as claimed in claim 2, wherein the original trained neural network model is denoted as y=(x@w₁+b₁)@w₂+b₂, w₁ and b₁ respectively represent an original weight and an original bias of a first linear operation layer of the original trained neural network model, w₂ and b₂ respectively represent an original weight and an original bias of a second linear operation layer of the original trained neural network model, and the simplification method further comprises:
calculating W_{I}=w₁@w₂ to determine the first new weight W_{I} of the simplified trained neural network model; and
calculating B_{I}=b₁@w₂+b₂ to determine the new bias B_{I} of the simplified trained neural network model.

5. The simplification method for neural network model as claimed in claim 1, further comprising:
calculating a second new weight of the at most two linear operation layers of the simplified trained neural network model by using at least one original weight of the original trained neural network model, wherein the simplified trained neural network model is denoted as y=W_{II}@(x@W_{I}+B_{I}), y represents an output of the simplified trained neural network model, @ represents any linear operation of the simplified trained neural network model, W_{II} represents the second new weight, x represents an input of the simplified trained neural network model, W_{I} represents the first new weight, and B_{I} represents a new bias of the simplified trained neural network model; and
calculating the second new weight B_{I} of the simplified trained neural network model by using at least one original weight and at least one original bias of the original trained neural network model.

6. The simplification method for neural network model as claimed in claim 5, wherein the original trained neural network model is denoted as y=((x@w₁+b₁)^{T}@w₂+b₂)^{T}@w₃, ( )^{T} represents a matrix transpose operation, w₁ and b₁ respectively represent an original weight and an original bias of a first linear operation layer of the original trained neural network model, w₂ and b₂ respectively represent an original weight and an original bias of a second linear operation layer of the original trained neural network model, w₃ represents an original weight of a third linear operation layer of the original trained neural network model, and the simplification method further comprises:
calculating W_{II}=(w₂)^{T} to determine the second new weight W_{II} of the simplified trained neural network model;
calculating W_{I}=w₁@w₃ to determine the first new weight W_{I} of the simplified trained neural network model; and
calculating B_{I}=b₁@w₃+((w₂)^{T})⁻¹@(b₂)^{T}@w₃ to determine the bias B_{I} of the simplified trained neural network model.

7. The simplification method for neural network model as claimed in claim 1, further comprising:
receiving the original trained neural network model;
converting the original trained neural network model into an original mathematical function;
performing an iterative analysis operation on the original mathematical function to simplify the original mathematical function to a simplified mathematical function, wherein the simplified mathematical function has the first new weight; and
converting the simplified mathematical function to the simplified trained neural network model.

8. The simplification method for neural network model as claimed in claim 7, wherein the original mathematical function is denoted as y=(( . . . ((x^{T0}@w₁+b₁)^{T1}@w₂+b₂)^{T2} . . . )^{Tn-1}@wₙ+bₙ)^{Tn}, y represents an output of the original mathematical function, x represents an input of the original mathematical function, T0 represents whether to transpose the input x, @ represents any linear operation of neural network model, w₁ and b₁ respectively represent an original weight and an original bias of a first linear operation layer of the original trained neural network model, T1 represents whether to transpose a result of the first linear operation layer, w₂ and b₂ respectively represent an original weight and an original bias of a second linear operation layer of the original trained neural network model, T2 represents whether to transpose a result of the second linear operation layer, Tn−1 represents whether to transpose a result of an (n−1)^{th} linear operation layer of the original trained neural network model, wₙ and bₙ respectively represent an original weight and an original bias of an n^{th} linear operation layer of the original trained neural network model, Tn represents whether to transpose a result of the n^{th} linear operation layer, and n is an integer greater than 1.

9. The simplification method for neural network model as claimed in claim 8, wherein the iterative analysis operation comprises n iterations, and a first iteration of the n iterations comprises:
taking the input x of the original mathematical function as a starting point, extracting (x^{T0}@w₁+b₁)^{T1} corresponding to the first linear operation layer from the original mathematical function;
defining X₁ as x;
checking T0;
defining F₁ as transposed X₁ when T0 represents “transpose”, defining F′₁ as F₁@w₁+b₁, and checking T1;
defining Y₁ as transposed F′₁ when T0 represents “transpose” and T1 represents “transpose”, so that Y₁=(w₁)^{T}@X₁+(b₁)^{T}, where ( )^{T} represents a transpose operation;
defining Y₁ as F′₁ when T0 represents “transpose” and T1 represents “not transpose”, so that Y₁=(X₁)^{T}@w₁+b₁;
defining F₁ as X₁ when T0 represents “not transpose”, defining F′₁ as F₁@w₁+b₁, and checking T1;
defining Y₁ as transposed F′₁ when T0 represents “not transpose” and T1 represents “transpose”, so that Y₁=(w₁)^{T}@(X₁)^{T}+(b₁)^{T};
defining Y₁ as F′₁ when T0 represents “not transpose” and T1 represents “not transpose” such that Y₁=X₁@w₁+b₁; and
replacing (x^{T0}@w₁+b₁)^{T1} in the original mathematical function with Y₁.

10. The simplification method for neural network model as claimed in claim 9, wherein a second iteration of the n iterations comprises:
extracting (Y₁@w₂+b₂)^{T2} corresponding to the second linear operation layer from the original mathematical function;
defining X₂ as Y₁;
defining F₂ as X₂;
defining F′₂ as F₂@w₂+b₂;
checking T₂;
defining Y₂ as transposed F′₂ when T2 represents “transpose”, so that Y₂=(w₂)^{T}@(X₂)^{T}+(b₂)^{T};
defining Y₂ as F′₂ when T2 represents “not transpose”, such that Y₂=X₂@W₂+b₂; and
replacing (Y₁@w₂+b₂)^{T2} in the original mathematical function with Y₂.

11. The simplification method for neural network model as claimed in claim 8, wherein the iterative analysis operation comprises n iterations, the simplified mathematical function is generated after the n iterations are completed, and the simplified mathematical function is denoted as y=W_{II}@(x@W_{I}+B_{I})+B_{II}, where W_{I} represents the first new weight, and the iterative analysis operation uses some or all of the original weights w₁ to wₙ to pre-calculate a first constant to serve as the first new weight W_{I}; W_{II} represents a second new weight of the at most two linear operation layers, and the iterative analysis operation uses at least one of the original weights w₁ to wₙ to pre-calculate a second constant to serve as the second new weight W_{II}; B_{I} represents a first new bias of the at most two linear operation layers, and the iterative analysis operation uses at least one of the original weights w₁ to wₙ and at least one of the original biases b₁ to bₙ to pre-calculate a third constant to serve as the first new bias B_{I}; B_{II} represents a second new bias of the at most two linear operation layers, and the iterative analysis operation uses “at least one of the original weights w₁ to wₙ” or “at least one of the original biases b₁ to bₙ” or “at least one of the original weights w₁ to wₙ and at least one of the original biases b₁ to bₙ” to pre-calculate a fourth constant to serve as the second new bias B_{II}.

12. A simplification device for neural network model, comprising:
a memory, storing a computer readable program; and
a processor, coupled to the memory to execute the computer readable program;
wherein the processor executes the computer readable program to realize the simplification method for neural network model as claimed in claim 1.

13. A non-transitory storage medium, for storing a computer readable program, wherein the computer readable program is executed by a computer to realize the simplification method for neural network model as claimed in claim 1.
